(19) United States
(12) Patent Application Publication
(10) Pub. No.: US 2013/0340533 A1
(43) Pub. Date: Dec. 26, 2013

(54) STRAIN GAUGE USING TWO-DIMENSIONAL MATERIALS

(71) Applicant: Massachusetts Institute of Technology, (US)

(72) Inventors: Mario Hofmann, Somerville, MA (US); Jing Kong, Winchester, MA (US)

(73) Assignee: Massachusetts Institute of Technology, Cambridge, MA (US)

(21) Appl. No.: 13/680,188

(22) Filed: Nov. 19, 2012

Related U.S. Application Data
(60) Provisional application No. 61/563,933, filed on Nov. 28, 2011.

(51) Int. Cl. G01L 1/22

(52) U.S. Cl. CPC G01L 1/22
USPC 73/777

(57) ABSTRACT

Strain gauge. The gauge includes a substrate and a thin film of overlapping, two-dimensional flakes deposited on the substrate. Structure responsive to conductance across the film is provided whereby a strain induced change in overlap area between neighboring flakes results in a change in conductance across the film. In a preferred embodiment, the two-dimensional flakes are graphene.

This application claims priority to provisional patent application Ser. No. 61/563,933 filed on Nov. 28, 2011, the contents of which are incorporated herein by reference.

This invention was made with government support under Grant No. N00014-09-1-1063 awarded by the Office of Naval Research. The government has certain rights in this invention.

### BACKGROUND OF THE INVENTION

This invention relates to strain gauges and more particularly to a strain gauge made of overlapping flakes of two-dimensional materials such as graphene.

Strain gauges are currently used in a variety of areas such as pressure sensors, maintenance activities and failure analysis. Currently there are several approaches to measuring the change of strain in a material by analyzing the change of its resistance. In one prior an approach, metal thin films are deposited on a backing layer and the strain-induced change in the cross-sectional area decreases their conductance. Such gauges can be produced cheaply, represent a mature technology but are not very sensitive. Piezoresistive strain gauges rely on a change in electronic structure of a material (i.e., a semiconductor) and offer high sensitivity but can only sustain small strain and are expensive. It has been reported to use graphene sheets as strain gauges but in these cases, graphene was used as a piezoresistive material. [1, 2, 3] The numbers in brackets refer to the references listed herein. These references are incorporated herein by reference. Yet another class of strain gauges uses polymers with conductive fillers that sense a change in conductance as the spacing between dispersed conductive particles or filaments change. This approach to strain gauge design can produce high sensitivity sensors but only for small strain. Furthermore, long-term stability and reliability have not been proven.

It is therefore an object of the present invention to provide a novel class of strain gauges that relies on a different strain sensing mechanism and can overcome limitations of current technologies.

### SUMMARY OF THE INVENTION

The strain gauge according to the invention includes a substrate and a thin film of overlapping, two-dimensional flakes deposited on the substrate. Structure is provided that is responsive to conductance across the film whereby a strain-induced change in overlap area between neighboring flakes results in a change in conductance across the film. In a preferred embodiment, the two-dimensional flakes are graphene. Other two-dimensional flakes could include microscopic flakes of thin metal foils (i.e. gold or copper leafs) or nanosheets composed of i.e. transition metal dichalcogenides (i.e. Molybdenum-disulfide (MoS₂) or Niobium-diselenide (NbSe₂)) or transition metal oxides. In a preferred embodiment of the invention, the films' sensitivity of conductance to strain is tuned by varying the morphology of the film. The morphology includes film thickness and flake size. The substrate may be any non-electrically conductive material. Suitable substrates can be plastic, glass or ceramic.

In a preferred embodiment of the invention, the film is deposited by spraying such as by airbrush deposition. The deposition may be from a solution containing the graphene flakes.

### BRIEF DESCRIPTION OF THE DRAWING

FIGS. 1a and 1b are schematic illustrations of an embodiment of the invention disclosed herein.

FIG. 2 is a graph of resistance change versus displacement for commercial strain gauges and for the device disclosed herein.

FIG. 3 is a graph of gauge factor versus resistance for graphene films.

FIG. 4 is a graph of gauge factor during repeated cycling.

FIG. 5a is a photograph of a transparent strain gauge according to the invention directly deposited onto a glass light bulb.

FIG. 5b is a graph showing tensile strain in a vertical direction.

FIG. 5c is a graph showing compressive strain in a horizontal direction.

### DESCRIPTION OF THE PREFERRED EMBODIMENT

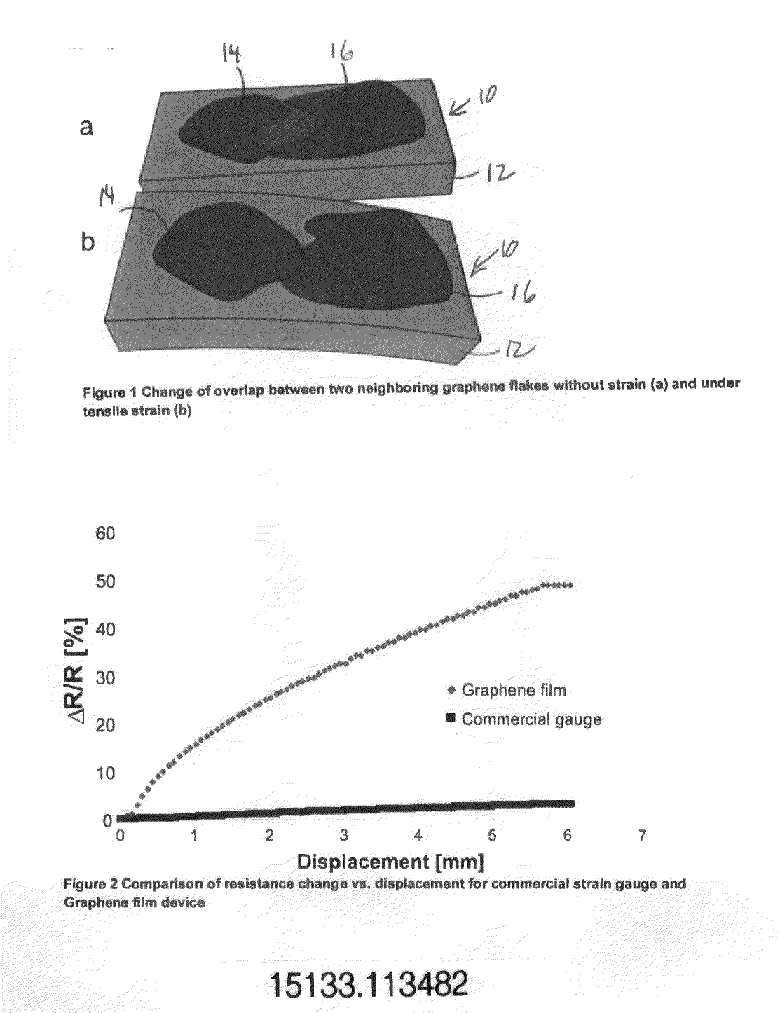

With respect first to FIG. 1, a strain gauge 10 includes a substrate 12 onto which is deposited graphene flakes 14 and 16. As shown in FIG. 1b, as the substrate 12 deforms, the flakes 14 and 16 move apart and overlap loss as compared to the unstrained substrate shown in FIG. 1a. As the overlap between the flakes 14 and 16 change, the conductance across the flakes will also vary, allowing a measurement of conductance to be associated with the induced strain.

The flakes 14 and 16 can be composed of two-dimensional materials such as graphene. Graphene flakes are composed of carbon sheets of a few atomic layers in thickness and represent a two-dimensional material. The flakes 14 and 16 may be deposited on the substrate 12 by spraying graphene flakes from a graphene flake solution by airbrush deposition, for example. While it is known to deposit graphene by spraying, the application of this technique for the present invention allows processing at atmospheric pressure whereas the fabrication of traditional strain gauges requires a vacuum. The spray deposition technique has no stringent requirements on the target substrate and strain gauges can be produced on plastic, glass, ceramics, etc. Virtually any non-electrically conducting substrate material may be used. High resolution features can be obtained by shadow mask deposition, if desired. Those of skill in the art will recognize that the deposition method used herein can deposit high sensitivity strain gauges directly onto existing structures.

We have demonstrated the novel principle disclosed herein by fabricating graphene strain gauges from graphene flake solution by airbrush deposition on PET substrates. The measured sensitivity, or gauge factor, of the strain gauge disclosed herein is approximately 10 times larger than previous graphene devices and approximately 20 times higher than metal thin film gauges and comparable to piezoresistive strain gauges. FIG. 2 is a graph of resistance change versus displacement for both a commercial prior art metal strain gauge and the graphene film device disclosed herein. Notice that the slope of the curve for graphene film has a slope of approximately 20 times that of the slope of the curve for the commercial gauge indicating the higher achievable sensitivity.

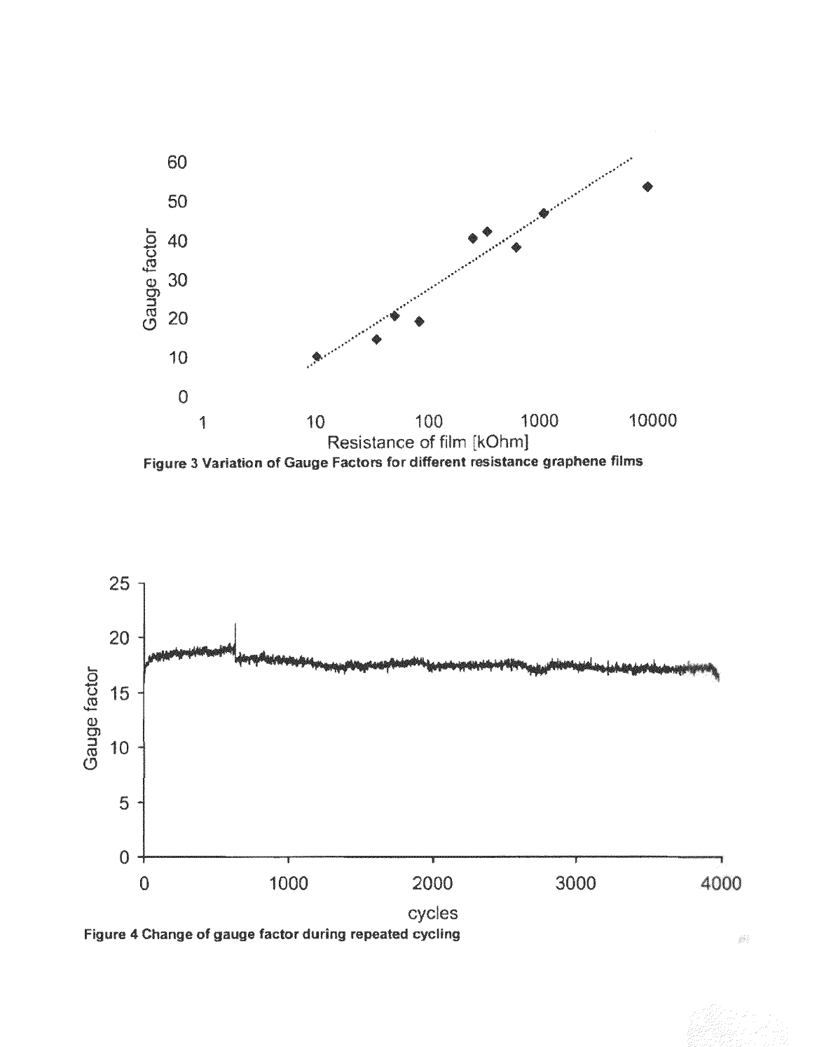

Importantly, we have demonstrated the ability to vary the gauge factor by orders of magnitude by changing the morphology of solution processed graphene flakes, i.e. the film thickness. See FIG. 3 that shows the effect on gauge factor of morphology dependent film resistance. The strain gauge disclosed herein exhibits long-term reliability. FIG. 4 is a plot of gauge factor against the number of strain cycles. Notice that the gauge factor is relatively constant even after 4000 cycles.

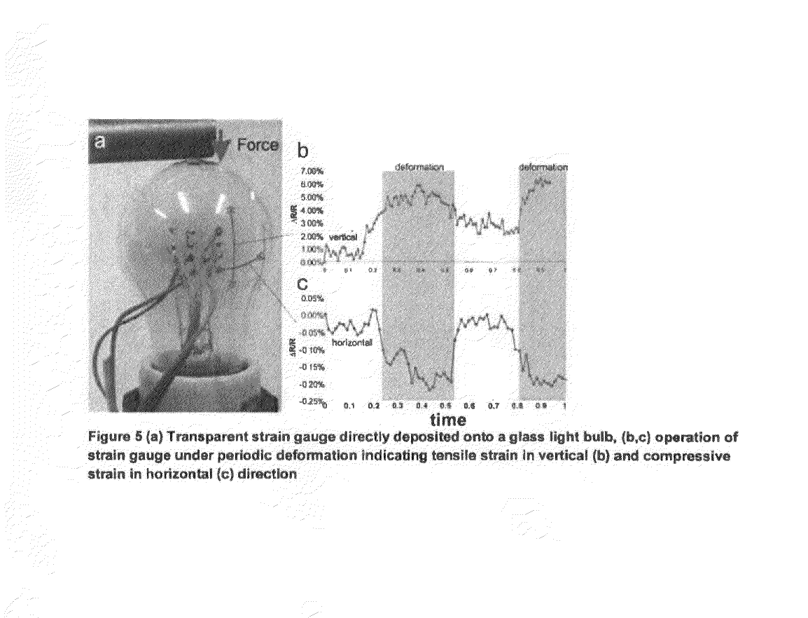

With reference to FIG. 5, FIG. 5a shows a transparent strain gauge comprising graphene flakes deposited directly on the outside face of a light bulb. FIG. 5b shows the operation of the strain gauge under periodic deformation resulting from tensile strain. FIG. 5c shows compressive strain in a horizontal direction.

The grain gauge disclosed herein provides several improvements over existing technology. Graphene as one embodiment, is composed of carbon which is chemically inert and can be used in reactive environments that are normally not accessible to prior art strain gauges. The temperature coefficient of resistivity for graphene is much smaller than that for other materials and the strains gauge according to the invention will not be as sensitive to temperature variation. Carbon also provides advantages for biocompatible devices.

The two-dimensional material of the invention is think and transparent opening new application areas such as glass break detectors, large scale transparent touch sensors, etc. Since graphene layers are coupled only by weak van der Waals interactions, a low friction gliding of the layers occurs, a property that is exploited in solid lubricants. This property allows for a long device lifetime. The graphene flakes that are deposited on a substrate are obtained from solutions that are readily available and are cheaply generated in large quantities. As mentioned above, the resistivity of the thin film can be adjusted by changes to the morphology, i.e., thickness, flake size, etc. and can thus be optimized for low power consumption (i.e., high resistivity) or large scale applications (i.e., low resistivity).

The combination of low material costs, scalable deposition, high sensitivity and novel material offer application of strain gauges in novel areas. Examples include implantable devices for health monitoring, transparent force-sensitive touch screens, large scale pressure sensors, micromechanical resistive strain sensors, and structural health monitoring of complex surfaces.

It is recognized that modifications and variations of the present invention will be apparent to those of ordinary skill in the art and it is intended that all such modifications and variations be included within the scope of the appended claims.

### REFERENCES

1. Kang, I.; Kim, Y. J.; Cha, J. Y.; Ham, H.; Huh, H.; So, D. S., Preparation of piezoresistive nano smart hybrid material based on graphene. Current Applied Physics 2011, 11 (1), S350-S352.
2. Hong, B. H.; Lee, Y.; Bae, S.; Jang, H.; Jang, S.; Zhu, S. E; Sim, S. H.; Song, Y. I.; Ann, J. H., Wafer-Scale Synthesis and Transfer of Graphene Films, Nano Letters 2010, 10 (2), 490-493.
3. Zhang, G. Y.; Wang, Y.; Yang, R.; Shi, Z. W.; Zhang, L. C.; Shi, D. X.; Wang, E., Super-Elastic Graphene Ripples for Flexible Strain Sensors. Acs Nano 2011, 5 (5), 3645-3650.

What is claimed is:

1. Strain gauge comprising:
a substrate;
a thin film of overlapping, two-dimensional flakes deposited on the substrate; and
structure responsive to conductance across the film, whereby a strain induced change in overlap area between neighboring flakes results in a change in conductance across the film.

2. The strain gauge of claim 1 wherein the two-dimensional flakes are graphene.

3. The strain gauge of claim 1 wherein the film's sensitivity of conductance to strain is tuned by varying the morphology of the film.

4. The strain gauge of claim 3 wherein the morphology includes film thickness.

5. The strain gauge of claim 3 wherein the morphology includes flake size.

6. The strain gauge of claim 1 wherein the substrate is non-electrically conductive.

7. The strain gauge of claim 6 wherein the substrate is plastic, glass or ceramic.

8. The strain gauge of claim 1 wherein the film is deposited by airbrush deposition from a graphene flake solution.

9. The strain gauge of claim 1 wherein spacing between flakes is smaller than flake size.

10. The strain gauge of claim 3 wherein the morphology is selected to produce at least a ten-fold increase in strain gauge sensitivity compared to prior art metal thin film gauges.
